(19) United States
(12) Patent Application Publication
(10) Pub. No.: US 2007/0190955 A1
(43) Pub. Date: Aug. 16, 2007

(54) Band-pass filter

(75) Inventor: Yen-Yi Shih, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,924

(22) Filed: Oct. 27, 2006

(30) Foreign Application Priority Data
Dec. 23, 2005 (TW) 94146339

(51) Int. Cl. H04B 1/26

(52) U.S. Cl. 455/198.1

(57) ABSTRACT

A band-pass filter (10) is provided. The band-pass filter includes an input line (100), an output line (120), a first coupling line (140), a second coupling line (160) and a resonator (180). The input line is used for inputting electromagnetic signals. The output line is used for outputting electromagnetic signals. The first coupling line is electronically connected to the input line. The second coupling line is disposed parallel to the first coupling line, and electronically connected to the output line. The resonator has a groove therein, and is disposed parallel to the first coupling line.

### FIELD OF THE INVENTION

The present invention generally relates to a filter used in communication devices, and more particularly to a band-pass filter used in communication devices.

### DESCRIPTION OF RELATED ART

In recent years, there has been a significant growth in WLAN (wireless local area network) technology due to the ever growing demand of wireless communication products. Such growth becomes particularly prominent after promulgation of the IEEE 802.11 WLAN protocol in 1997. The IEEE 802.11 WLAN protocol not only offers many novel features to current wireless communications, but also provides a solution of enabling two wireless communication products manufactured by different companies to communicate with each other. As such, the promulgation of the IEEE 802.11 WLAN protocol is a milestone in the development of WLAN. Moreover, the IEEE 802.11 WLAN protocol ensures that a core device is the only solution of implementing a single chip. Thus, the IEEE 802.11 WLAN protocol can significantly reduce the cost of adopting wireless technology, so as to enable WLAN to be widely employed in various wireless communication products.

Conventionally, electromagnetic signals are generated when a wireless communication product, such as an access point complying with IEEE 802.11 standard transfers data at high power, these electromagnetic signals may cause electromagnetic interference (EMI).

For solving the above problem, some manufacturers in the art use a waveguide element, such as a microstrip, to act as a filter. The microstrip filter is disposed on a printed circuit board to diminish harmonic electromagnetic signals and to pass an EMI test conducted on a wireless communication product. This is particularly true for electromagnetic signals having second, third, fourth or more harmonics of a fundamental frequency. However, the microstrip filter is not very compact and takes up precious space on the printed circuit board.

Therefore, a heretofore unaddressed need exists in the industry to provide a compact band-pass filter.

### SUMMARY OF THE INVENTION

An aspect of the present invention provides a band-pass filter. The band-pass filter includes an input line, an output line, a first coupling line, a second coupling line and a resonator. The input line is used for inputting electromagnetic signals. The output line is used for outputting electromagnetic signals. The first coupling line is electronically connected to the input line. The second coupling line is disposed parallel to the first coupling line, and electronically connected to the output line. The resonator having a groove disposed therein is disposed parallel to the first coupling line.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a band-pass filter in accordance with an exemplary embodiment of the invention; and

FIG. 2 is a graph showing a relationship between insertion/return loss and frequency of electromagnetic signals traveling through the band-pass filter.

### DETAILED DESCRIPTION OF THE INVENTION

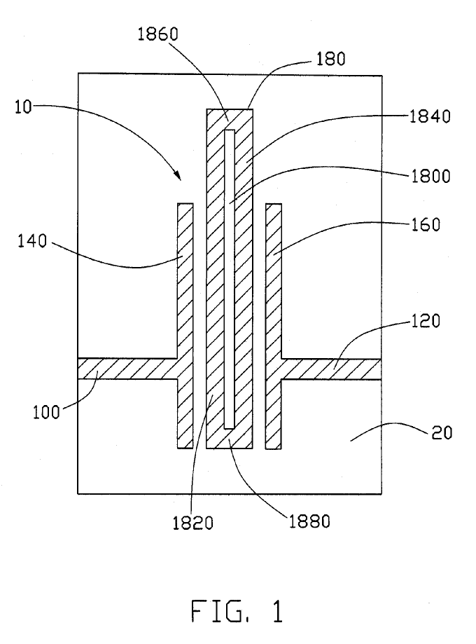

FIG. 1 is a schematic diagram of an exemplary band-pass filter 10 in accordance with the present invention.

The band-pass filter 10, which is printed on a substrate 20, is used for cutting out harmonic electromagnetic signals. The band-pass filter 10 includes an input line 100, an output line 120 corresponding to the input line 100, a first coupling line 140, a second coupling line 160, and a resonator 180.

The input line 100 inputs electromagnetic signals. The output line 120 outputs electromagnetic signals. The input line 100 is in line with the output line 120. The impedances of the input line 100 and the output line 120 of the band-pass filter 10 are approximately 50 ohms. Therefore, an impedance converter is not needed in the band-pass filter 10 for minimizing the region of the band-pass filter 10.

The first coupling line 140 is electronically connected to the input line 100. The second coupling line 160 is parallel to the first coupling line 140, and is electronically connected to the output line 120.

The resonator 180 is disposed between the first coupling line 140 and the second coupling line 160. The resonator 180 includes a third coupling line 1820, a fourth coupling line 1840, a fifth coupling line 1860, and a sixth coupling line 1880, which are connected end to end, and cooperate to form a closed-loop shape or a hollow rectangle with a groove 1800 therein.

A length, a width, and a shape of the third coupling line 1820 are same as those of the fourth coupling line 1840. The third coupling line 1820 is disposed parallel to the first coupling line 140. The fourth coupling line 1840 is disposed parallel to the second coupling line 160. The sixth coupling line 1880 is disposed parallel to the fifth coupling line 1860. A width, a length, and a shape of the fifth coupling line 1860 are same as those of the sixth coupling line 1880. The third coupling line 1820 and the fourth coupling line 1840 are perpendicular to the fifth coupling line 1860 and the sixth coupling line 1880. That is the groove 1800 is defined by the third coupling line 1820, the fourth coupling line 1840, the fifth coupling line 1860, together with the sixth coupling line 1880.

The third coupling line 1820 and the first coupling line 140 form a first capacitance for inputting the electromagnetic signals from the input line 100 to the resonator 180. The fourth coupling line 1840 and the second coupling line 160 form an output capacitance for outputting the electromagnetic signals from the resonator 180 to the output line 120. A shortest length of a feed trace between the input line 100 and the output line 120 is equal to a quarter of a perimeter of the groove 1800 for controlling transmitting zero points close to the pass band. A good performance is obtained by adjusting values of the first capacitance and the second capacitance.

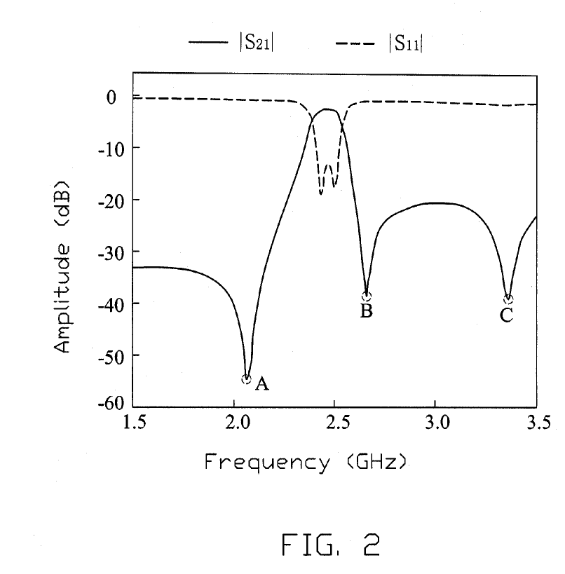

FIG. 2 is a graph showing a relationship between an insertion or return loss and frequency of an electromagnetic signal traveling through the band-pass filter 10. The horizontal axis represents a frequency (in GHz) of, and the vertical axis represents an insertion or return loss (in dB) of the band-pass filter 10. The insertion loss of an electromagnetic signal traveling through the band-pass filter 10 is indicated by the curve labeled S21 and indicates a relationship between input power and output power of the electromagnetic signals traveling through the band-pass filter 10, and is represented by the following equation:
Insertion Loss=−10*Lg[(Input Power)/(Output Power)].
When the electromagnetic signals travel through the band-pass filter 10, a part of the input power is returned to a source of the electromagnetic signals. The part of the input power returned to the source of the electromagnetic signal is called return loss. The return loss of an electromagnetic signal traveling through the band-pass filter 10 is indicated by the curve labeled S11 and indicates a relationship between the input power and the return power of the electromagnetic signal traveling through the band-pass filter 10, and is represented by the following equation:
Return Loss=−10*Lg[(Input Power)/(Return Power)].

For a filter, when the output power of the electromagnetic signal in a band-pass frequency range is close to the input power thereof, and the return loss of the electromagnetic signal is small, it means that a distortion of the electromagnetic signal is small and the performance of the band-pass filter is good. That is, the less the absolute value of the insertion loss of the electromagnetic signal is, the greater the absolute value of the return loss thereof is, and the better the performance of the filter is. As shown in FIG. 2, the absolute value of the insertion loss of the electromagnetic signal in the band-pass frequency range is close to 0, and the absolute value of the return loss of the electromagnetic signal is greater than 10, therefore the band-pass filter 10 has good performance.

Transmitting zero points A and B are close to the pass band of the pass-band filter 10 to suppress noise signals of stop band. Furthermore, transmitting zero point C is generated to more effectively suppress noise signals of stop band.

The band-pass filter 10 effectively suppresses noise by use of the groove 1800, the first capacitance, and the second capacitance. And the compact nature of the band-pass filter 10 conserves space on a printed circuit board.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A band-pass filter comprising:
an input line for inputting electromagnetic signals;
an output line for outputting electromagnetic signals;
a first coupling line electronically connected to the input line;
a second coupling line parallel to the first coupling line, and electronically connected to the output line;
a resonator having a groove disposed therein, disposed parallel to the first coupling line.

2. The band-pass filter as recited in claim 1, wherein the impedances of the input line and the output line of the band-pass filter are approximately 50 ohms.

3. The band-pass filter as recited in claim 1, wherein the input line is in line with the output line.

4. The band-pass filter as recited in claim 1, wherein the groove is in a shape of rectangle, and is disposed in center portion of the resonator.

5. The band-pass filter as recited in claim 1, wherein the resonator comprises a third coupling line disposed parallel to the first coupling line.

6. The band-pass filter as recited in claim 5, wherein the resonator further comprises a fourth coupling line disposed parallel to the second coupling line.

7. The band-pass filter as recited in claim 6, wherein a length and a width of the third coupling line are same as those of the fourth coupling line.

8. The band-pass filter as recited in claim 6, wherein a shape of the third coupling line is same as that of the fourth coupling line.

9. The band-pass filter as recited in claim 6, wherein the third coupling line and the fourth coupling line form a first capacitance for inputting the electromagnetic signals from the input line to the resonator.

10. The band-pass filter as recited in claim 6, wherein the fourth coupling line and the second coupling line form an outputting capacitance for outputting the electromagnetic signals from the resonator to the output line.

11. The band-pass filter as recited in claim 6, wherein the resonator further comprises a fifth coupling line, and sixth coupling line disposed parallel to the fifth coupling line.

12. The band-pass filter as recited in claim 11, wherein a width and a length of the fifth coupling line are same as those of the sixth coupling line.

13. The band-pass filter as recited in claim 11, wherein the groove is defined by the third coupling line, the fourth coupling line, the fifth coupling line together with the sixth coupling line.

14. The band-pass filter as recited in claim 1, wherein a shortest length of feeding trace is equal to a quarter of a perimeter of the groove.

15. A band-pass filter comprising:
an input end for inputting electromagnetic signals;
an output end corresponding to the input end, for outputting electromagnetic signals;
a first coupling line, electronically connected to the input end;
a second coupling line, parallel to the first coupling line and electronically connected to the output end;
a resonator, disposed between the first coupling line and the second coupling, and defining a groove therein.

16. The band-pass filter as recited in claim 15, wherein the resonator comprises a third coupling line, a fourth coupling line, a fifth coupling line, and a sixth coupling line.

17. A band-pass filter comprising:
an input line for inputting electromagnetic signals;
an output line for outputting said electromagnetic signals;
a first coupling line electrically connectable with said input line to receive said input electromagnetic signals from said input line;
a second coupling line spaced from said first coupling line and electrically connectable with said output line to transmit said electromagnetic signals to said output line for outputting; and
a resonator disposed between said first coupling line and said second coupling line, and spaced from both of said first and second coupling lines, said resonator formed as a closed-loop shape and electrically coupling with said first and second coupling lines respectively in order to transmit and filter said electromagnetic signals passing through said resonator.

18. The band-pass filter as recited in claim 17, wherein said resonator comprises a third coupling line extending parallel to said first coupling line, and a fourth coupling line extending parallel to said second coupling line.
